(19) United States
(12) Patent Application Publication
(10) Pub. No.: US 2026/0153413 A1
(43) Pub. Date: Jun. 4, 2026

(54) SYSTEM AND METHOD FOR MULTIPLE LIQUID SAMPLE CAPTURE AND ANALYSIS FROM AERIAL DRONES

(71) Applicant: WILL LEWIS CONSULTING, LLC, Claymont, DE (US)

(72) Inventors: William H. Lewis, Claymont, DE (US); Jan du Preez, Johannesburg (ZA)

(73) Assignee: WILL LEWIS CONSULTING, LLC, Claymont, DE (US)

(21) Appl. No.: 19/461,061

(22) Filed: Jan. 27, 2026

Related U.S. Application Data
(63) Continuation-in-part of application No. 18/026,776, now Pat. No. 12,545,407.
(60) Provisional application No. 63/085,540, filed on Sep. 30, 2020.

(51) Int. Cl. G01N 1/14; B64U 20/00; B64U 101/35; G01N 1/02; G01N 15/1434

(52) U.S. Cl. CPC G01N 1/14; B64U 20/00; G01N 15/1436; B64U 2101/35; G01N 2001/021

(57) ABSTRACT

A system, method, and computer program product for capture of multiple liquid samples from an aerial drone, include an aerial drone; one or more liquid sample receptacles disposed within respective receptacle containing units provided on the aerial drone; an analytical dock assembly integrated with the aerial drone and configured to receive at least one of the receptacle containing units after liquid sample capture; a drive system configured to lower and raise the one or more liquid sample receptacles and the respective receptacle containing units into a body of liquid to capture multiple liquid samples from the body of liquid; and a detachable dock assembly integrated within the analytical dock assembly and configured to extract, process, and analyze liquid samples from the at least one receptacle containing unit after the receptacle containing unit docks with the analytical dock assembly.

### CROSS REFERENCE TO RELATED DOCUMENTS

The present disclosure is a continuation in part patent application of U.S. patent application Ser. No. 18/026,776 of William H. LEWIS et al., entitled “SYSTEM AND METHOD FOR MULTIPLE LIQUID SAMPLE CAPTURE FROM AERIAL DRONES,” filed on 16 Mar. 2023, now allowed, which claims priority to PCT Patent Application Serial No. PCT/US2021/052427 of William H. LEWIS et al., entitled “SYSTEM AND METHOD FOR MULTIPLE LIQUID SAMPLE CAPTURE FROM AERIAL DRONES,” filed on 28 Sep. 2021, now inactive, which claims priority to U.S. Provisional Patent Application Ser. No. 63/085,540 of William H. LEWIS et al., entitled “SYSTEM AND METHOD FOR MULTIPLE LIQUID SAMPLE CAPTURE FROM AERIAL DRONES,” filed on 30 Sep. 2020, now inactive, the entire disclosures of all of which are hereby incorporated by reference herein.

### BACKGROUND OF THE INVENTION

### Field of the Invention

The present invention generally relates to liquid sample capture systems and methods, and more particularly to liquid sample capture and analysis systems and methods employing aerial drones, and the like.

### Discussion of the Background

In recent years, sample capture systems and methods have been developed. However, such systems and methods lack precision and efficiency with respect to liquid sample capture and analysis employing aerial drones, and the like.

### SUMMARY OF THE INVENTION

Therefore, there is a need for a system and subsequent method that addresses the above and other problems. The above and other problems are addressed by the illustrative embodiments of the present invention, which is capable of collecting and analyzing water or other liquid samples more efficiently than current methods by increasing the number of samples collected per unit time and reducing operational dependencies such as the number of teams or technicians required while ensuring that sampling and analysis are conducted in a manner consistent with best practices, cross-contamination between sites is limited, and data quality standards are met. This system and method for multiple liquid sample capture (MLSC) and analysis using an aerial drone includes an array of one or more sample capture units (SCU), receptacles protected by orifice covers and/or external housings or shrouds, that can be deployed independently from a dock attached to the aerial drone via a winch mechanism at desired sampling locations and sampling times. When triggered, one or more SCUs drop from the aerial drone to collect a water or other liquid sample before returning to the protected housing or shroud and closing orifice covers. The aerial drone can then travel to another location and deploy additional SCUs to take water or other liquid samples based on the volume requirements and payload limitations of the platform without exposing previously collected sample(s) to cross-contamination during sampling or transit to and between sampling locations and a home base. The SCUs are interchangeable with one or more compatible end effectors such as sensors or sensor packages and/or onboard analytical components capable of characterizing liquid conditions (e.g., nitrate, nitrites, ammonia, pH, temperature, chlorophyll, microbial DNA densities, microplastics, dissolved oxygen, turbidity, chlorine, spectral analysis, etc.).

Accordingly, in illustrative aspects of the present invention there is provided a system, method, and computer program product for capture of multiple liquid samples from an aerial drone, including an aerial drone; one or more liquid sample receptacles disposed within respective receptacle containing units provided on the aerial drone; an analytical dock assembly integrated with the aerial drone and configured to receive at least one of the receptacle containing units after liquid sample capture; a drive system configured to lower and raise the one or more liquid sample receptacles and the respective receptacle containing units into a body of liquid to capture multiple liquid samples from the body of liquid; and a detachable dock assembly integrated within the analytical dock assembly and configured to extract, process, and analyze liquid samples from the at least one receptacle containing unit after the receptacle containing unit docks with the analytical dock assembly.

The detachable dock assembly includes a sealed, needle-based extraction interface configured to pierce a diaphragm of the receptacle containing unit after docking and withdraw a controlled aliquot of liquid while a bulk liquid sample remains sealed within the receptacle.

The detachable dock assembly further includes a microfluidic flow path comprising tubing, a filter, and a motor-piezoelectric membrane pump configured to draw liquid through the flow path for analysis.

The detachable dock assembly includes an optical analysis subsystem comprising an optical light source, an optical light path, a fiber-optic flow cell, and a spectrophotometer configured to measure optical characteristics of the liquid sample.

The detachable dock assembly further includes a waste trap configured to retain residual liquid following analysis, such that analyzed liquid is retained onboard the aerial drone rather than discharged into an external environment.

The detachable dock assembly includes a printed circuit board configured to control analytical operations and associate analytical results with metadata including at least one of a geographic location, a time stamp, or a sampling identifier, and to store or transmit the results while the aerial drone is in flight or transit.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative representation of a multiple liquid sample capture (MLSC) system in transit state;

FIG. 2 is an illustrative representation of the multiple liquid sample capture (MLSC) system as shown in FIG. 1 in a sampling state with one end effector, such as a sample capture unit (SCU) 1000 or sensor package deployed for execution of liquid collection or liquid characterization process;

FIG. 3 is an illustrative exploded representation of the multiple liquid sample capture (MLSC) retrofit system of FIGS. 1-2;

FIG. 4 is an illustrative representation of core central functional structure of the multiple liquid sample capture (MLSC) system of FIGS. 1-3 that includes mechanical attachment points for auxiliary subsystems;

FIG. 5 is an illustrative representation of a dock system component that holds sample capture units (SCU) or end effectors securely in place at a docking point when not deployed;

FIG. 6 is an illustrative representation of a detachable dock similar to the dock of FIG. 5 but with a mechanical architecture that includes core attachment points (CAP) for ease of attachment and detachment;

FIG. 7 is an illustrative representation of sprung winch spool (SWS) controlled in rotation by a drive gear for raising and lowering of the sample capture units (SCU) or end effectors to access a liquid of interest;

FIG. 8 is an illustrative representation of a drive system, central actuation mechanism or element for sample capture unit (SCU) 1000 or end effector activation and subsequent deployment and recovery;

FIG. 9 is an illustrative representation of a shroud mechanical barrier between both individual sample capture units (SCU) or end effectors and other SCUs or end effectors and the surrounding environment;

FIG. 10 is an illustrative representation of a sample capture unit (SCU) subsystem that is deployed from the multiple liquid sample capture (MLSC) system to passively capture liquid through submersion at a chosen sample site;

FIG. 11 is an illustrative representation of a lockable capsule lid (LCL) subassembly of the sample capture unit (SCU) to isolate a sample receptacle from cross-contamination;

FIG. 12 is an illustrative representation of an analytical dock assembly integrated with the multiple liquid sample capture (MLSC) system and configured to receive a plurality of sample capture units (SCU) and perform onboard analytical processing of liquid samples;

FIGS. 13A-13B are illustrative representations of the analytical dock assembly of FIG. 12, showing detailed lateral and perspective views of onboard analytical components configured to extract, process, and analyze liquid samples captured by a sample capture unit (SCU); and

FIG. 14 is an illustrative flow diagram of a method for capturing multiple liquid samples from an aerial drone and subsequent onboard extraction, processing, analysis, and transmission of liquid sample data using the analytical dock assembly described in connection with FIGS. 12 and 13A-13B.

### DETAILED DESCRIPTION OF THE PREFERRED EMBODIMENTS

The present invention includes recognition that current efforts to collect surface water samples from marine or inland water bodies involve teams manually collecting samples from slow moving boats, docks, or the shoreline. Teams of two or more technicians are typically required to carry out sampling using best practices to limit the chances of cross-contamination between sites and ensure that data quality standards are met. Sampling programs developed using current best practices typically result in very high cost per sample collected given the number of teams involved and travel between locations translating to limited sampling over both space and time. A small number of academic and commercial entities have retrofitted aerial drones to collect water samples in an effort to increase sampling efficiency and reduce travel time between locations. However, these existing aerial drone water sampling retrofit designs have not been developed from the perspective of sampling best practices to meet data quality standards and allow for hardware to come into contact with the water surface at multiple sampling locations leading to cross-contamination between sites.

Generally, the described method and system include an actuation system capable of deploying one or more receptacles or receptacle containing units to collect samples of a liquid. A mechanism is provided to lower and/or raise one or more receptacles or receptacle containing units at a time when activated. An orifice cover or lid for a receptacle or receptacle containing unit allows for the release of a gas and passive filling of a liquid. The orifice cover or lid for a receptacle or receptacle containing unit prevents the ingress of a gas or liquid unless opened and deployed. A receptacle lid closure and seal protect receptacle orifices or pathways for filling from cross-contamination during ground transport, aerial drone flight, or liquid capture at other sites. An external housing or shroud is employed to limit the potential for cross-contamination during ground transport, aerial drone flight, or liquid capture at other sites. Handling logic for multiple liquid sampling receptacles and subsystems are provided so as to deploy and collect discrete liquid samples, while seeking to avoid cross-contamination, as well as the deployment and re-use steps inherent in the design. A source to test multiple liquid sample capture (MLSC) retrofit hardware, software, and service architecture is provided enabling efficient interfacing with third party aerial drone solutions as well as control of deployment/docking hardware through embedded system radio control and drive system processes.

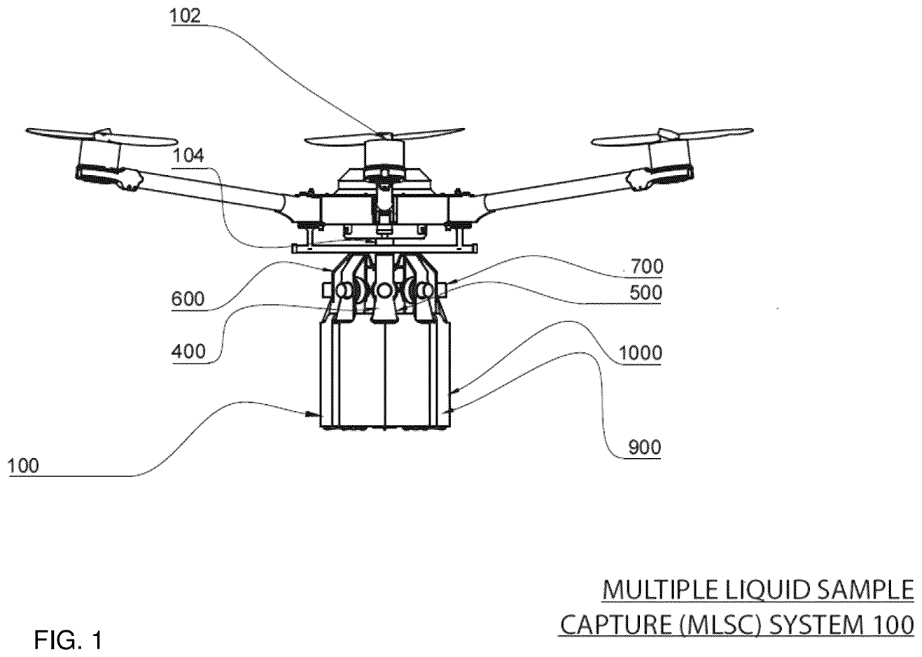

Referring now to the drawings, wherein like reference numerals designate identical or corresponding parts throughout the several views, and more particularly to FIG. 1 thereof, there is shown an illustrative representation of a multiple liquid sample capture (MLSC) system in transit state. In FIG. 1, the multiple liquid sample capture (MLSC) system 100 includes auxiliary subsystems such as the core 400, dock 500, detachable docks 600, sprung winch spools (SWS) 700, shrouds 900, and sample capture units (SCU) 1000. The MLSC system 100 is capable of passively capturing liquid samples through submersion or other non-mechanical means (e.g., gear driven, mechanical actuator driven, magnetic driven, etc.) at chosen sample sites from a maintained above liquid surface state. The system does this by utilizing lift generated by a computer controlled aerial drone 102 with dynamic, controlled actuation by an operator or autonomous agent. The lift capabilities of aerial drone 102 enables the MLSC system 100 to be flown on a safe path to an initial liquid sampling site, passively collect one or more samples at a site or location through the submersion or other non-mechanical means, and then be returned safely to a position of choice. The propulsion system of the aerial drone 102 enables the spatial translation of the system shown in FIG. 1 from a base, to one or more sample sites and then again back to a base. The MLSC system 100 will be in transit state as shown in FIG. 1 with all sample receptacles 1106 or end effectors protected from direct and indirect cross-contamination via one or more mechanical components including the shroud 900, SCU 1000, and lockable capsule lid (LCL) 1100 during transit to and between sampling locations and a home base. An MLSC system 100 device is retrofitted or attached to an aerial drone 102 of choice through a drone platform-specific drone attachment 104.

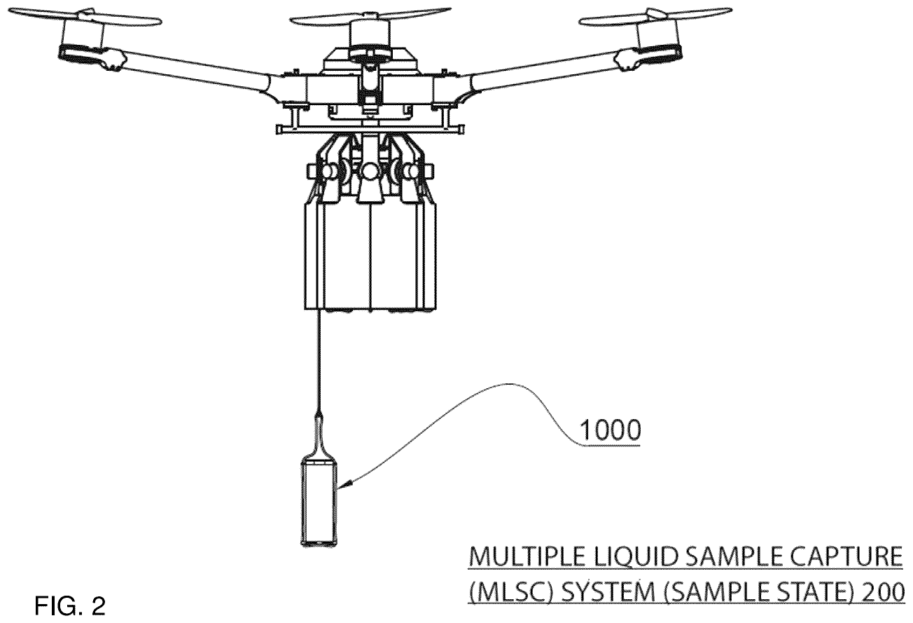

FIG. 2. is an illustrative representation of the multiple liquid sample capture (MLSC) system 100 as shown in FIG. 1 in a sampling state with one sample capture unit (SCU) 1000 or end effector released from the protection of the shroud 900, lockable capsule lid (LCL) 1100 disarmed with flow doors 1002 open, the drive system 800 engaged and driving the sprung winch spool (SWS) 700 to lower the SCU 1000 or end effector toward the target liquid surface. The SWS 700 is driven in the opposite direction to recover the SCU 1000 following passive liquid capture through submersion with the LCL 1100 rearmed with doors closed when the lid returns to the docking point 502. The sample capture process for a given location and time is concluded when the shroud 900 is returned to protect the SCU 1000 or end effector subsystem from cross-contamination during subsequent transit between sampling locations and a home base.

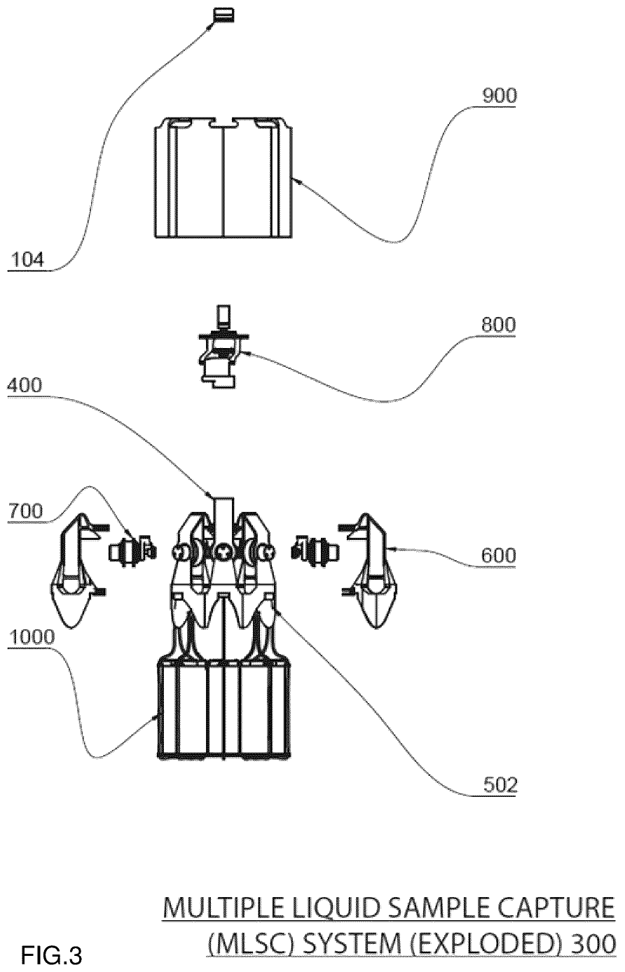

FIG. 3 is an illustrative exploded representation of the multiple liquid sample capture (MLSC) system 100 to more effectively present the drive system 800, drone attachment 104 and docking point 502 that are not readily visible in the non-exploded system representation views presented in FIG. 1 and FIG. 2. Assembly of the modular MLSC system 100 generally includes the attachment of the drive system 800 to the core 400 for all possible configurations. Detachable docks 600 are then attached to the core 400 consistent with the use case and payload limitations of the aerial drone 102 platform. Sprung winch spools (SWS) 700 are then attached to the dock 500 and detachable docks 600 present before sample capture units (SCU) 1000 and shrouds 900 are added to complete the system. The MLSC retrofit system 100 is affixed to the aerial drone 102 at drone attachment 104.

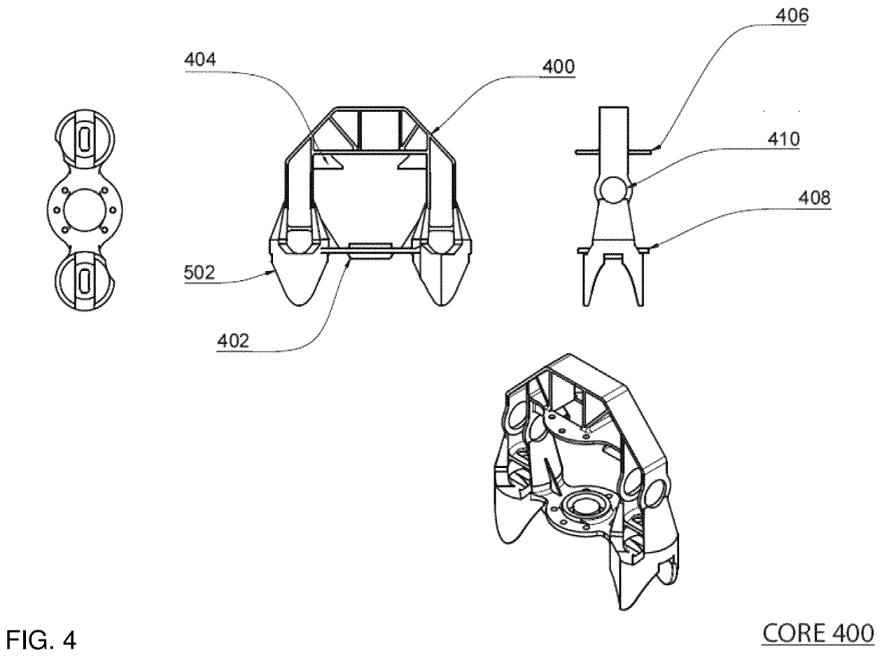

FIG. 4 is an illustrative representation of the core 400 of the multiple liquid sample capture (MLSC) system 100. The core 400 resists all foreseeable static and dynamic forces of the system given its intended application and is mechanically attached to the aerial drone 102 via the drone attachment 104. The core also acts as a mechanical hub for the system wherein auxiliary components such as detachable docks 600 can be attached to achieve complete MLSC system 100 assembly consistent with the use case and payload limitations of the aerial drone 102 platform.

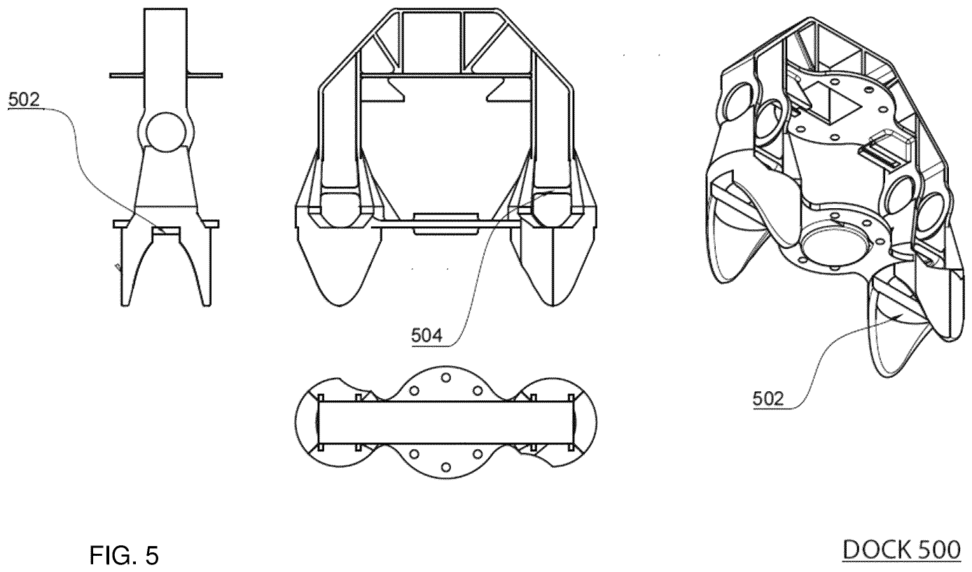

FIG. 5 is an illustrative representation of the dock 500, a component built directly into the multiple liquid sample capture (MLSC) system 100 and core 400 presented in FIG. 4 which provides a mechanical holster for the initial individual or pair of sample capture units (SCU) 1000 or end effectors. This dock holds SCUs 1000 or end effectors present securely in place at the docking point 502 at all times except when they are being deployed including during aerial drone 102 transit to and between sampling locations and a home base.

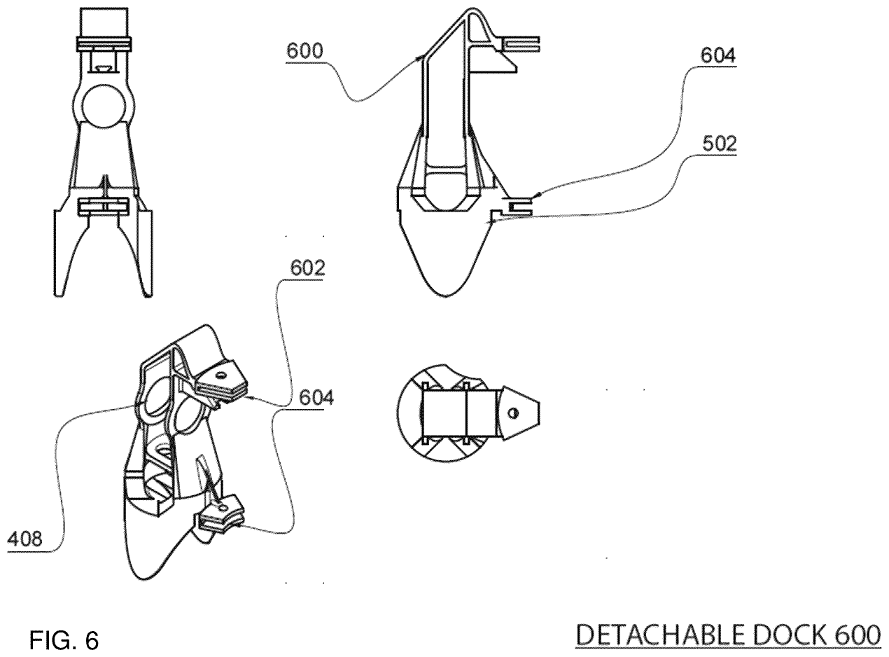

FIG. 6 is an illustrative representation of the detachable dock 600 which assumes a role identical to the dock 500. However, it includes a mechanical architecture such as a core attachment point (CAP), shown as components 602 and 604, that make it easily attachable and detachable from the core 400 and therefore the multiple liquid sample capture (MLSC) system 100. This detachability incorporates modularity into the MLSC system 100 and enables it to be readily configured with any number of sample capture units (SCU) 1000 or end effectors as a function of the number of available detachable docks 600, CAPs, and payload limitations associated with the aerial drone 102 platform. One or more detachable docks 600 can be added to the system to expand the number of discrete samples to be captured or the sample capacity of the device to align with the use case. The dock 500 and detachable dock 600 and their respective elements support the actuation, lowering and/or raising, of the SCU 1000 or end effectors at sample sites and provide mechanical support to the SCUs 1000 or end effectors during transit between sampling locations and a home base.

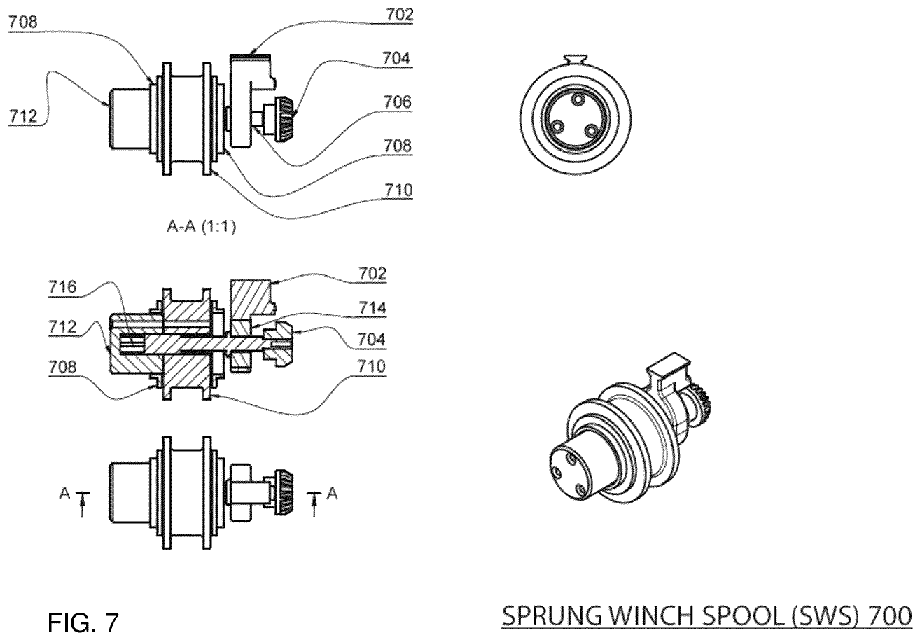

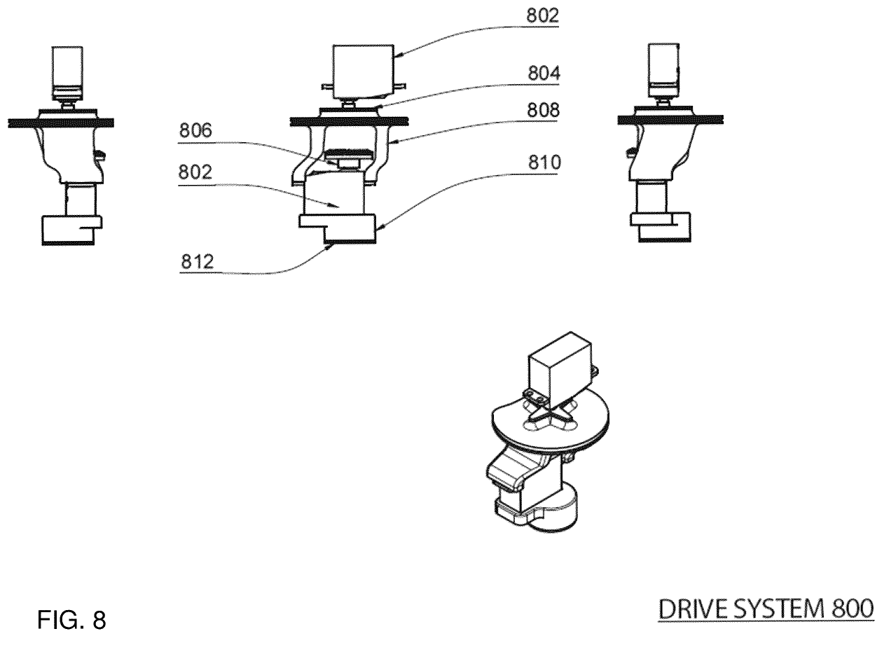

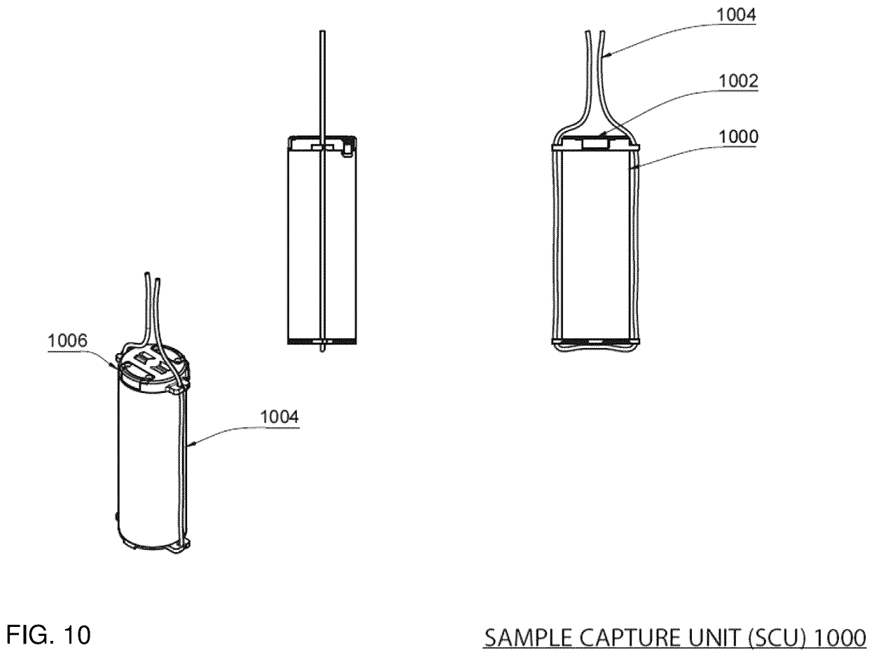

FIG. 7 is an illustrative representation of the sprung winch spool (SWS) 700, a system that enables the rotation of a spooled line or cable system to lower and/or raise the sample capture unit (SCU) 1000 or end effector to access the liquid of interest during deployment. The SWS 700 can exist in one of two states at any given time, rotate and lock, and can be sequenced by control of the drive system 800 detailed in FIG. 8. This feature is governed by the unidirectional sequential architecture of the drive system 800 that holds SCUs 1000 or end effectors within their docks 500 or detachable docks 600 at their docking points 502 and shrouds 900 when they are not deployed. This SCU 1000 configuration during multiple liquid sample capture (MLSC) system 100 transit state limits the potential for the unwanted ingress of a gas, liquid, or other environmental media during aerial drone deployment, transit, and recovery procedures. The SWS 700 is an advantageous part of the MLSC system 100 as it drives the armed/disarmed state change of the lockable capsule lid (LCL) 1100 and therefore the SCU 1000 or end effector shown in FIG. 10. When the drive system 800 presented in FIG. 8 sequences an SCU 1000 or end effector to begin deployment, the spring chamber 712 will extend the linear slide 702 to align drive gear 806 and driven gear 704. This gear alignment establishes a mechanical connection that allows for the rotation of the winch drum 710 enabled by rotational degree of freedom at the bearing 708 interface.

FIG. 8 is an illustrative representation of drive system 800 which includes an upper motor 802 mechanically coupled via a motor mount 804 to cam bracket 808 to rotate the cam structure and the remaining drive system 800, lower motor 802, drive seat 810, and drive gear 806 on a rotational degree of freedom enabled by the drive seat bearing (DSB) 812. The sequenced rotation of drive system 800 around the aforementioned degree of freedom moves cam bracket 808 to a position that extends or compresses spring chamber 712. In between the temporal extension and compression of the spring chamber 712, while the spring is fully extended, the lower motor 802 powers drive gear 806 in a specifically designed power sequence to rotate the sprung winch spool (SWS) 700, lower and/or raise the sample capture unit (SCU) 1000 or end effector, and carry out the passive liquid capture sampling process.

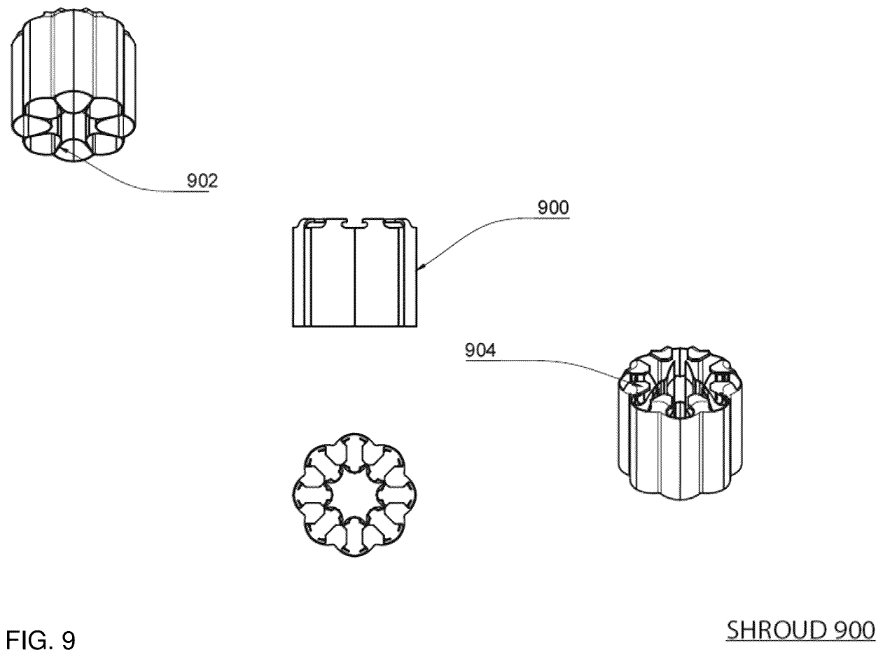

FIG. 9 is an illustrative representation of the shroud 900, an external sample capture unit (SCU) 1000 enclosure to prevent the unwanted ingress of a gas, liquid, or other environmental media into receptacle 1106 during aerial drone 102 deployment, transit, and recovery procedures between sample locations or return to home base. The shroud 900 provides a mechanical barrier between both individual SCUs 1000 or end effectors and other SCUs 1000 or end effectors and the surrounding environment. SCUs 1000 or end effectors are held securely in place at the docking point 502 and covered by the shroud 900 at all times unless they are deployed to sampling position as shown in FIG. 2. The shroud 900 is modular and can be added or removed from the multiple liquid sample capture (MLSC) system 100 for each SCU 900 or end effector via the mechanical shroud attachment 904 to meet the needs of additional use cases and address payload limitations of the aerial drone 102 platform.

FIG. 10 is an illustrative representation of the sample capture unit (SCU) 1000 which is a passive, liquid sample receptacle subsystem that can be deployed from the multiple liquid sample capture (MLSC) system 100 to capture liquid at a chosen sample site while preventing the unwanted ingress of a gas, liquid, or other environmental media into receptacle 1106 during aerial drone deployment, transit, and recovery procedures between sample locations or return to home base. As indicated in the narrative descriptions for FIG. 4 and FIG. 5, the system is modular in nature allowing for the installation and removal of detachable docks 600, sprung winch spools (SWS) 700, and SCUs 1000 consistent with the application of the system and payload limitations of the aerial drone 102 platform. The SCU 1000 can be readily replaced with one or more end effectors such as generic liquid sampling structures, sensors, or sensor packages (e.g., nitrate, nitrites, ammonia, pH, temperature, chlorophyll, microbial DNA densities, microplastics, dissolved oxygen, turbidity, chlorine, spectral analysis, etc.) via attachment by cable 1004.

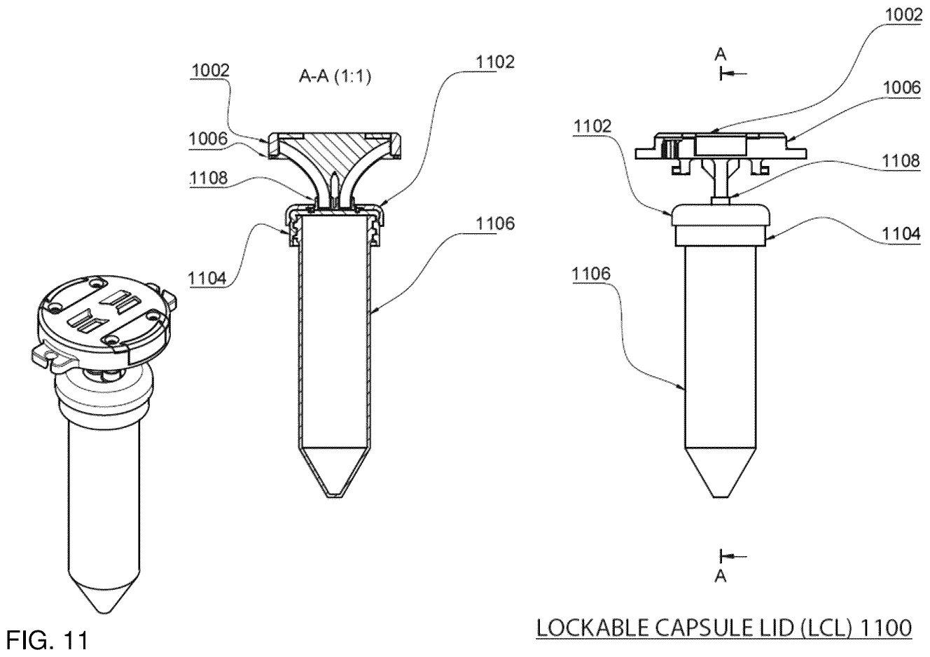

FIG. 11 is an illustrative representation of the lockable capsule lid (LCL) 1100, an advantageous subassembly of the sample capture unit (SCU) 1000 including two mechanisms to isolate receptacle 1106 from cross-contamination and prevent the unwanted ingress of a gas, liquid, or other environmental media into during aerial drone 102 deployment, transit, and recovery procedures. The first mechanism includes a lid 1006 that can be set to either an armed or unarmed position through rotation. The armed position corresponds with open cap orifices allowing for the ingress and egress of gases liquids while the unarmed position corresponds to a closed position mechanically isolating receptacle 1106. The unarmed setting is analogous to a closed standard cap and is expected to be used during SCU 1000 assembly and preparation or post-sampling prior to liquid processing. The second mechanism to isolate the sample receptacle within the LCL 1100 subassembly are the flow doors 1002. These flow doors 1002 are closed when the LCL 1100 and broader SCU 1000 are docked to the aerial drone 102 at the docking point 502. The LCL 1100 is transitioned to sampling state when the drive system 800 initiates deployment, the SWS 700 is engaged, and the flow doors 1002 are opened as the SCU 1000 is initially lowered toward the liquid of interest consistent with the sample state shown in FIG. 2. Liquid is allowed to fill the sample receptacle 1106 through open flow doors 1002 and sample receptacle cap (SRC) 1104 when the SCU 1000 is submerged. The flow doors 1002 are subsequently closed upon SCU 1000 recovery and return to the docking point 502 effectively sealing the SRC 1104 and the liquid sample within the receptacle 1106.

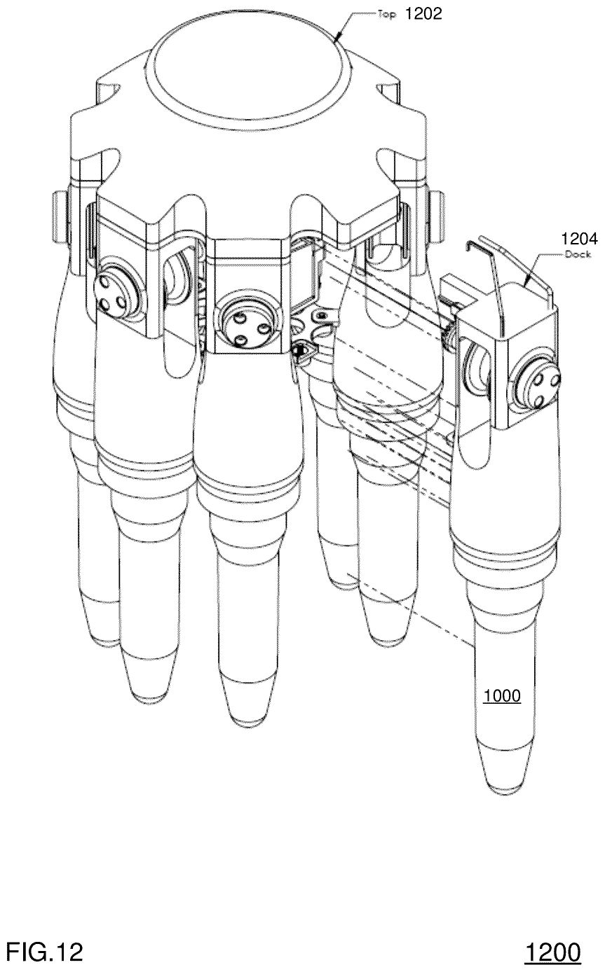

FIG. 12 is an illustrative representation of an analytical dock assembly integrated with the multiple liquid sample capture (MLSC) system and configured to receive a plurality of sample capture units (SCU) and perform onboard analytical processing of liquid samples. In FIG. 12, an analytical dock assembly 1200 is shown in an assembled, perspective view, the analytical dock assembly 1200 including a central upper housing portion 1202 forming a structural top of the assembly and a plurality of detachable dock assemblies 1204 arranged circumferentially about the central upper housing portion 1202. Each detachable dock assembly 1204 is configured to mechanically receive, retain, and support a corresponding sample capture unit (SCU) 1000 in a docked position when the SCU 1000 is not deployed for sampling and analysis. As illustrated, the detachable dock assemblies 1204 are uniformly distributed around the analytical dock assembly 1200 to form a multiple dock configuration, enabling the analytical dock assembly 1200 to concurrently carry a plurality of SCUs 1000.

Each detachable dock assembly 1204 is mechanically coupled to the analytical dock assembly 1200 and extends downwardly from the central upper housing portion 1202, providing a defined docking location for a respective SCU 1000. The SCUs 1000 are shown retained in a vertically oriented, docked configuration beneath the detachable dock assemblies 1204, such that each SCU 1000 is supported for deployment from and retrieval to the MLSC system in a manner consistent with previously described docking and deployment architectures. The central upper housing portion 1202 provides a common structural interface for the detachable dock assemblies 1204 and is configured to enclose and support additional subsystems of the analytical dock assembly 1200, while the detachable dock assemblies 1204 define lower docking regions configured to interface with the SCUs 1000 when returned from a sampling operation.

In the illustrated embodiment, the analytical dock assembly 1200 is shown supporting multiple detachable dock assemblies 1204, for example including eight detachable dock assemblies, although fewer or greater numbers of detachable dock assemblies can be employed depending on application requirements, sampling objectives, and payload limitations of the aerial drone platform. The configuration shown in FIG. 12 illustrates the modular and scalable nature of the analytical dock assembly 1200, wherein the detachable dock assemblies 1204 and corresponding SCUs 1000 can be arranged to enable multiple sample capture while providing a structural foundation for subsequent post-capture processing and analysis as described in connection with later figures.

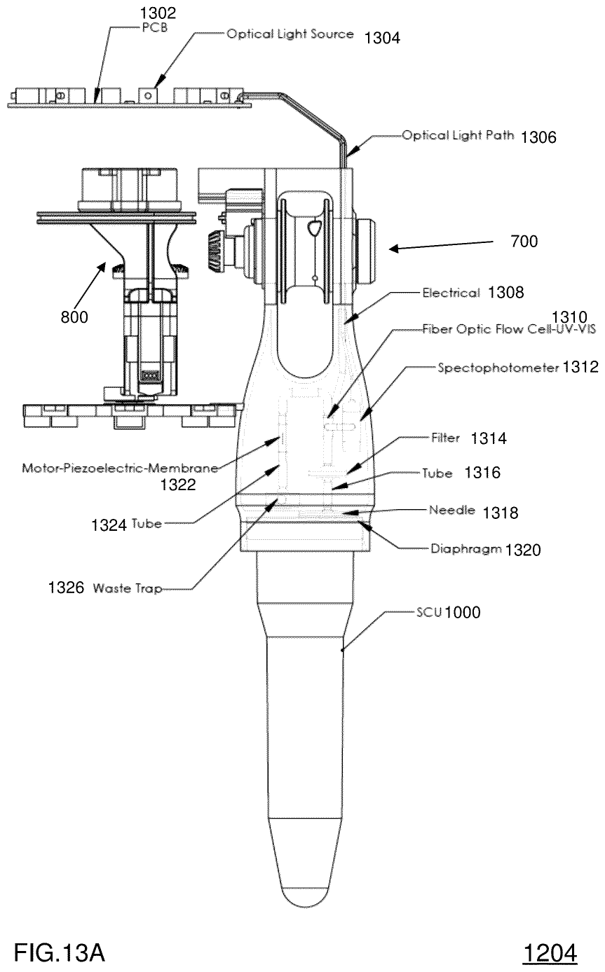

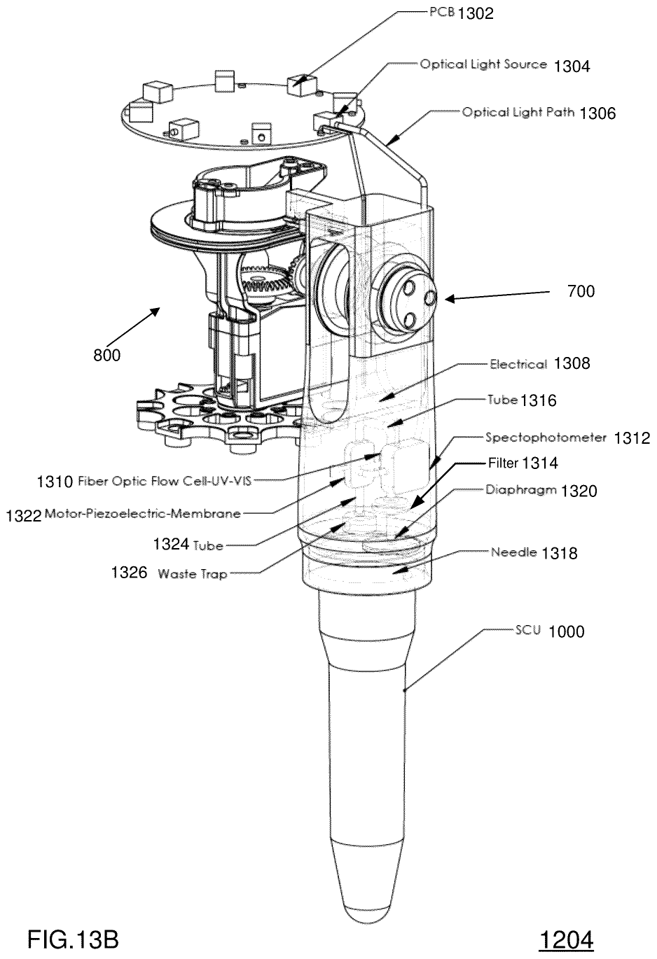

FIGS. 13A-13B are illustrative representations of the analytical dock assembly of FIG. 12, showing detailed lateral and perspective views of onboard analytical components configured to extract, process, and analyze liquid samples captured by a sample capture unit (SCU). In FIGS. 13A-13B, illustrative representations of the analytical dock assembly 1204 of FIG. 12 are shown in detailed lateral and perspective views to depict an onboard analytical subsystem integrated into the multiple liquid sample capture (MLSC) system and configured to extract, process, and analyze liquid samples captured by a sample capture unit (SCU) 1000 while the SCU 1000 remains docked to the MLSC system. As illustrated, the analytical dock assembly 1204 includes a printed circuit board (PCB) 1302 positioned within an upper portion of the dock assembly, the PCB 1302 being operatively coupled to one or more optical light sources 1304 and configured to control analytical operations, fluidic actuation, optical excitation, and processing of analytical signals. Light generated by the optical light source 1304 is transmitted along an optical light path 1306 toward downstream analytical components.

As further shown in FIGS. 13A-13B, the analytical dock assembly 1204 is configured to interface with a docked SCU 1000 via a sealed, needle-based extraction interface. In the illustrated embodiment, a needle 1318 is arranged to penetrate a diaphragm 1320 associated with the SCU 1000 after the SCU 1000 has been retrieved from a sampling location and returned to its docking point. Advantageously, this configuration enables withdrawal of a controlled aliquot of liquid from the SCU 1000 without opening the SCU 1000 or exposing the bulk sample to the surrounding environment, thereby maintaining cross-contamination protection. Extracted liquid is directed upwardly from the needle 1318 into the analytical dock assembly 1204 for processing.

Liquid extracted from the SCU 1000 is conveyed through the analytical dock assembly 1204 along a defined fluidic path including one or more tubes 1316 and 1324. Movement of the liquid through the fluidic path is driven by a motor-piezoelectric membrane component 1322 configured to draw liquid through the system. The fluidic path further includes a filter 1314 arranged upstream of optical analysis components, the filter 1314 being configured to remove particulates, debris, or other matter that could interfere with downstream optical measurements or fluid flow. By filtering the extracted liquid prior to analysis, the system advantageously improves signal quality and reliability of analytical results.

Following filtration, the extracted liquid is directed through a fiber optic flow cell 1310 that cooperates with a spectrophotometer 1312. Light transmitted along the optical light path 1306 passes through the liquid within the fiber optic flow cell 1310, enabling the spectrophotometer 1312 to measure optical characteristics of the liquid sample, such as absorption or transmission, to facilitate determination of chemical composition and concentrations of dissolved constituents. Electrical connections 1308 provide signal communication between the spectrophotometer 1312 and the PCB 1302 for processing and storage of analytical data.

As further illustrated, liquid exiting the spectrophotometer 1312 is routed via the fluidic path to a waste trap 1326, wherein residual liquid is retained within the analytical dock assembly 1204 rather than discharged into the surrounding environment. This retained-waste configuration accommodates the small analytical volumes processed by the system and preserves cleanliness of the MLSC system. The arrangement of the tubes 1316, 1324, motor-piezoelectric membrane component 1322, filter 1314, fiber optic flow cell 1310, spectrophotometer 1312, and waste trap 1326 collectively defines a compact onboard analytical pathway integrated within the dock assembly.

FIGS. 13A-13B further illustrate that the analytical dock assembly 1204 is mechanically integrated with previously disclosed subsystems of the MLSC system, including the drive system 800 and the sprung winch spool (SWS) 700, such that analytical functionality is added without altering core deployment, retrieval, and isolation mechanics of the MLSC system. This integration enables onboard analysis of liquid samples following capture while preserving modularity, scalability, and compatibility with aerial drone platforms and multiple sample collection operations.

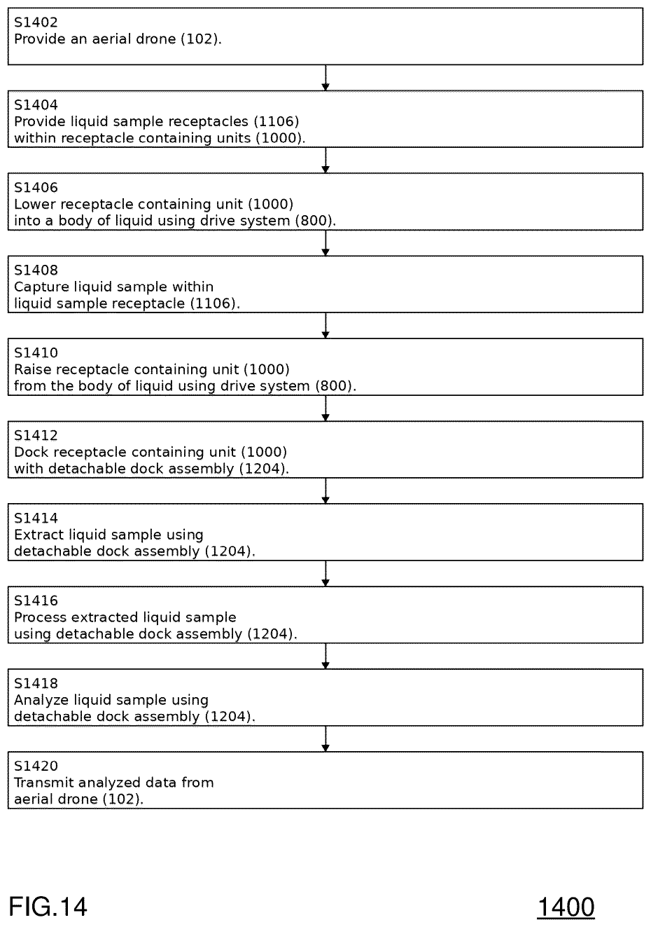

FIG. 14 is an illustrative flow diagram of a method for capturing multiple liquid samples from an aerial drone and subsequent onboard extraction, processing, analysis, and transmission of liquid sample data using the analytical dock assembly described in connection with FIGS. 12 and 13A-13B. In FIG. 14, the flow diagram 1400 begins at step S1402, in which an aerial drone 102 is provided, the aerial drone being configured to support flight operations and to carry a multiple liquid sample capture (MLSC) system including deployment, docking, and analytical subsystems. At step S1404, one or more sample capture units (SCU) 1000 are provided on the aerial drone 102, each SCU 1000 acting as a liquid sample receptacle and being supported in a docked configuration by a corresponding detachable dock assembly 1204 integrated within an analytical dock assembly 1200.

At step S1406, a selected SCU 1000 is lowered from the aerial drone 102 into a body of liquid using a drive system 800, such as a sprung winch spool and associated drive mechanism, enabling controlled deployment of the SCU 1000 to a desired sampling depth. At step S1408, while the SCU 1000 is submerged, a liquid sample is captured, for example through passive filling during submersion. Following sample capture, at step S1410, the SCU 1000 is raised from the body of liquid using the drive system 800 and returned to a docked position beneath the analytical dock assembly 1200.

At step S1412, the SCU 1000 is mechanically docked with a detachable dock assembly 1204, which extends downwardly from a central upper housing portion 1202 of the analytical dock assembly 1200, thereby securing the SCU 1000 in a docked position suitable for post-capture processing and analysis. Once docked, a sealed, the needle-based extraction interface 1318 associated with the detachable dock assembly 1204 penetrates the diaphragm 1320 of the SCU 1000 to withdraw a controlled aliquot of liquid from the captured sample, while a bulk portion of the liquid sample remains sealed within the SCU 1000. Advantageously, this configuration enables post-capture extraction without opening the SCU 1000 or exposing the bulk sample to the surrounding environment, thereby preserving sample integrity and reducing the risk of cross-contamination.

At step S1414, the extracted liquid is conveyed through an onboard microfluidic flow path defined within the detachable dock assembly 1204, the flow path including the tubing 1316 and 1324, the filter 1314, and the motor-piezoelectric membrane component 1322 configured to draw liquid through the system. The filter 1314 removes particulates or debris prior to analysis, thereby improving signal quality and reliability of subsequent measurements. At step S1416, the filtered liquid sample is directed through the fiber optic flow cell 1310 and optically analyzed using the optical analysis subsystem including the optical light source 1304, the optical light path 1306, and the spectrophotometer 1312 configured to measure optical characteristics of the liquid sample, such as absorption or transmission, to facilitate determination of chemical composition or concentration of dissolved constituents.

At step S1418, analytical operations of the detachable dock assembly 1204 are coordinated and controlled by the printed circuit board (PCB) 1302 housed within the analytical dock assembly 1200. The PCB 1302 processes analytical signals and associates analytical results with metadata including, for example, a geographic location of sampling, a time stamp, and a sampling identifier corresponding to the SCU 1000. At step S1420, the analytical results and associated metadata are stored and/or transmitted from the aerial drone 102 while the aerial drone remains in flight or transit, enabling near real-time availability of liquid characterization data.

Advantageously, the method illustrated in FIG. 14 enables multiple SCUs 1000 to be deployed, retrieved, and analyzed during a single flight, leveraging the modular and scalable analytical dock assembly 1200 described in FIG. 12. By performing extraction and analysis while each SCU 1000 remains docked to a respective detachable dock assembly 1204, the method preserves sample integrity, minimizes cross-contamination, and avoids degradation of sample chemistry associated with extended storage or transport. Additionally, onboard analytical processing and in-flight transmission of results enable rapid access to liquid characterization data, supporting time-sensitive monitoring, adaptive sampling strategies, and efficient use of aerial drone platforms across multiple sampling locations.

It is to be understood that the method and system of the illustrative embodiments are for illustrative purposes, as many variations of the specific hardware used to implement the illustrative embodiments are possible, as will be appreciated by those skilled in the relevant art(s). The functionality of one or more of the components of the illustrative embodiments can be implemented via similar designs. For example, the above-described method and system of the illustrative embodiments can include any number of discrete sample receptacles made of any material, shape, or size deployed or actuated by any trigger mechanism.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for capture of multiple liquid samples from an aerial drone, the system comprising:
an aerial drone;
one or more liquid sample receptacles disposed within respective receptacle containing units provided on the aerial drone;
an analytical dock assembly integrated with the aerial drone and configured to receive at least one of the receptacle containing units after liquid sample capture;
a drive system configured to lower and raise the one or more liquid sample receptacles and the respective receptacle containing units into a body of liquid to capture multiple liquid samples from the body of liquid; and
a detachable dock assembly integrated within the analytical dock assembly and configured to extract, process, and analyze liquid samples from the at least one receptacle containing unit after the receptacle containing unit docks with the analytical dock assembly.

2. The system of claim 1, wherein the detachable dock assembly includes a sealed, needle-based extraction interface configured to pierce a diaphragm of the receptacle containing unit after docking and withdraw a controlled aliquot of liquid while a bulk liquid sample remains sealed within the receptacle.

3. The system of claim 1, wherein the detachable dock assembly further includes a microfluidic flow path comprising tubing, a filter, and a motor-piezoelectric membrane pump configured to draw liquid through the flow path for analysis.

4. The system of claim 1, wherein the detachable dock assembly includes an optical analysis subsystem comprising an optical light source, an optical light path, a fiber-optic flow cell, and a spectrophotometer configured to measure optical characteristics of the liquid sample.

5. The system of claim 1, wherein the detachable dock assembly further includes a waste trap configured to retain residual liquid following analysis, such that analyzed liquid is retained onboard the aerial drone rather than discharged into an external environment.

6. The system of claim 1, wherein the detachable dock assembly includes a printed circuit board configured to control analytical operations and associate analytical results with metadata including at least one of a geographic location, a time stamp, or a sampling identifier, and to store or transmit the results while the aerial drone is in flight or transit.

7. A method for capture of multiple liquid samples from an aerial drone, the method comprising:
providing an aerial drone;
providing on the aerial drone one or more liquid sample receptacles disposed within respective receptacle containing units;
lowering and raising, using a drive system, the one or more liquid sample receptacles and the respective receptacle containing units into a body of liquid to capture multiple liquid samples from the body of liquid;
receiving, with an analytical dock assembly integrated with the aerial drone, at least one of the receptacle containing units after liquid sample capture; and
extracting, processing, and analyzing, using a detachable dock assembly integrated within the analytical dock assembly, liquid samples from the at least one receptacle containing unit after the receptacle containing unit docks with the analytical dock assembly.

8. The method of claim 7, further comprising:
extracting a controlled aliquot of liquid from the receptacle containing unit after docking by piercing a diaphragm of the receptacle containing unit using a sealed, needle-based extraction interface, while maintaining a bulk liquid sample sealed within the receptacle.

9. The method of claim 7, further comprising:
conveying the extracted liquid through a microfluidic flow path comprising tubing, a filter, and a motor-piezoelectric membrane pump, and drawing the liquid through the flow path for analysis.

10. The method of claim 7, further comprising:
optically analyzing the extracted liquid using an optical analysis subsystem comprising an optical light source, an optical light path, a fiber-optic flow cell, and a spectrophotometer to measure optical characteristics of the liquid sample.

11. The method of claim 7, further comprising:
retaining residual liquid following analysis in a waste trap, such that analyzed liquid is retained onboard the aerial drone rather than discharged into an external environment.

12. The method of claim 7, further comprising:
controlling analytical operations using a printed circuit board of the detachable dock assembly, and associating analytical results with metadata including at least one of a geographic location, a time stamp, or a sampling identifier, and storing or transmitting the analytical results while the aerial drone is in flight or transit.

13. A non-transitory computer-readable medium for capture of multiple liquid samples from an aerial drone, with instructions stored thereon, that when executed by a processor, performs the steps comprising:
providing an aerial drone;
providing on the aerial drone one or more liquid sample receptacles disposed within respective receptacle containing units;
lowering and raising, using a drive system, the one or more liquid sample receptacles and the respective receptacle containing units into a body of liquid to capture multiple liquid samples from the body of liquid;
receiving, with an analytical dock assembly integrated with the aerial drone, at least one of the receptacle containing units after liquid sample capture; and
extracting, processing, and analyzing, using a detachable dock assembly integrated within the analytical dock assembly, liquid samples from the at least one receptacle containing unit after the receptacle containing unit docks with the analytical dock assembly.

14. The non-transitory computer-readable medium of claim 13, further comprising instructions that, when executed by the processor, cause the processor to:
extract a controlled aliquot of liquid from the receptacle containing unit after docking by piercing a diaphragm of the receptacle containing unit using a sealed, needle-based extraction interface, while maintaining a bulk liquid sample sealed within the receptacle.

15. The non-transitory computer-readable medium of claim 13, further comprising instructions that, when executed by the processor, cause the processor to:
convey the extracted liquid through a microfluidic flow path comprising tubing, a filter, and a motor-piezoelectric membrane pump, and draw the liquid through the flow path for analysis.

16. The non-transitory computer-readable medium of claim 13, further comprising instructions that, when executed by the processor, cause the processor to:
optically analyze the extracted liquid using an optical analysis subsystem comprising an optical light source, an optical light path, a fiber-optic flow cell, and a spectrophotometer to measure optical characteristics of the liquid sample.

17. The non-transitory computer-readable medium of claim 13, further comprising instructions that, when executed by the processor, cause the processor to:
retain residual liquid following analysis in a waste trap, such that analyzed liquid is retained onboard the aerial drone rather than discharged into an external environment.

18. The non-transitory computer-readable medium of claim 13, further comprising instructions that, when executed by the processor, cause the processor to:
control analytical operations using a printed circuit board of the detachable dock assembly, associate analytical results with metadata including at least one of a geographic location, a time stamp, or a sampling identifier, and store or transmit the analytical results while the aerial drone is in flight or transit.
